(19) United States
(12) Patent Application Publication
(10) Pub. No.: US 2012/0214935 A1
(43) Pub. Date: Aug. 23, 2012

(54) METHOD FOR IMPROVED POLYESTER RESIN BLENDS FOR OXYGEN SCAVENGING AND PRODUCTS THEREOF

(75) Inventors: Mark Ryan Roodvoets, Duncan, SC (US); Frank Wilhelm Embs, Charlotte, NC (US)

(73) Assignee: INVISTA NORTH AMERICA S.A.R.L., Wilmington, DE (US)

(21) Appl. No.: 13/395,306

(22) PCT Filed: Sep. 10, 2010
(86) PCT No.: PCT/US10/48370

§ 371 Date: May 9, 2012

Related U.S. Application Data
(60) Provisional application No. 61/241,591, filed on Sep. 11, 2009.

(51) Int. Cl. C08L 67/06; C08L 67/00

(52) U.S. Cl. 524/539; 525/419

(57) ABSTRACT

Disclosed is a method for producing an oxygen scavenging resin comprising: a) reacting an aromatic diacid or its diester, and an ionic diacid or its diester, with a diol and a metal compound to produce an ionic copolyester, b) cooling, cutting and drying the ionic copolyester into solid pellets, and c) mixing the dried ionic copolyester with a dried oxidizable polymer, provided that the oxidizable polymer is not a partially aromatic polyamide. Also disclosed is i) a composition made by the above method wherein the composition comprises an ionic copolyester, containing a metal compound, and an oxidizable polymer, provided that the oxidizable polymer is not a partially aromatic polyamide; and ii) the method of making articles from this composition.

### CROSS-REFERENCE TO RELATED APPLICATION

This application claims benefit of priority from U.S. Provisional Application No. 61/241,591 filed Sep. 11, 2009.

### FIELD OF THE INVENTION

The present invention relates to a method for preparing active oxygen scavenging copolyesters for molding articles with improved clarity and shorter induction times.

### BACKGROUND OF THE INVENTION

Polyesters have been replacing glass and metal packaging materials due to their lighter weight, decreased breakage compared to glass, and potentially lower cost. One major deficiency with polyesters is its relatively high gas permeability. This restricts the shelf life of carbonated soft drinks and oxygen sensitive materials such as beer and fruit juices. Organic oxygen scavenging materials have been developed partly in response to the food industry's goal of having longer shelf-life for packaged food.

One method of addressing gas permeability which is currently being employed involves the use of “active packaging” where the package is modified in some way so as to control the exposure of the product to oxygen. Such “active packaging” can include sachets containing iron based compositions which scavenges oxygen within the package through an oxidation reaction.

Other techniques of addressing gas permeability involve incorporating an oxygen scavenger into the package structure itself. In such an arrangement, oxygen scavenging materials constitute at least a portion of the package, and these materials remove oxygen from the enclosed package volume which surrounds the product or which may leak into the package, thereby inhibiting spoilage and prolonging freshness in the case of food products.

Oxygen scavenging materials in this environment include low molecular-weight oligomers that are typically incorporated into polymers or can be oxidizable organic polymers in which either the backbone or the side-chains of the polymer react with oxygen. Such oxygen scavenging materials are typically employed with a suitable catalyst, for example, an organic or inorganic salt of a transition metal catalyst such as cobalt.

A partially aromatic polyamide based on m-xylylenediamine, in particular MXD6, is commonly used as the oxidizable organic polymer. MXD6 being a high barrier polymer provides both a passive barrier to oxygen and carbon dioxide as well as an active scavenging oxygen polymer in the presence of a transition metal catalyst such as a cobalt salt.

The following references disclose using a masterbatch of the ionic compatibilizer and/or the transition metal salt in polyester that is then blended with a polyester and an oxidizable polymer. WO2005/023530 to Mehta et al. discloses the use of an ionic compatibilizer, such as sodium 5-sulfoisophthalate ionic copolyester, to reduce the haze of monolayer containers prepared from a blend of PET and partially aromatic polyamides (MXD6). The examples use a master batch of the ionic compatibilizer and/or the transition metal salt in polyester that is then blended with the MXD6. WO 2009/032560 to Chen et al. discloses a copolyesterether comprising a oxidizable polyether segment of poly(tetramethylene-co-alkylene ether). The transition metal salt was added as a masterbatch and blended with base polyester and the copolyesterether at injection molding.

WO 2006/062816 to Stewart et al. teaches that the deficiencies accompanying the incorporation of the transition metal salt during polymerization, such as a lengthy induction period before full activity is achieved or life time (capacity) which are too short, can be overcome by using a master batch of the transition metal. Specifically, Stewart et al. teaches that copolymerizing a cobalt salt was not as effective at catalyzing oxygen scavenging reactions in blends of polyester and MXD6 as adding a cobalt masterbatch.

The following references disclose adding a transition metal catalyst during mixing or blending of a polyester and an oxidizable polymer. WO 2007/049232 to Ferrari et al. discloses the use of lithium 5-sulfoisophthate ionic copolyesters for use in blends with MXD6. Examples using a melt phase polymerized ionic copolyester in blends with MXD6 gave comparable average MXD6 domain size, and hence % haze, to blends made with a master batch of the ionic copolyester. Other oxidizable polymers have been disclosed and commercialized. U.S. Pat. No. 6,863,988 to Tibbitt et al. disclose monolayer packages comprised of an oxygen scavenging composition having a modified copolymer of predominantly polyester segments and an oxygen scavenging amount of oxygen scavenging segments, such as polybutadiene. The transition metal salt is added during a reactive polymerization of a hydroxyl terminated polybutadiene and a polyester. This product is sold under the trade name of Amosorb® by ColorMatrix. U.S. Pat. No. 6,455,620 to Cyr et al. discloses polyethers, such as poly(alkylene glycols), as oxygen scavenging moieties blended with thermoplastic polymers and a transition metal catalyst at injection molding.

### SUMMARY OF THE INVENTION

Unfortunately, the cited art above either results in an article with low haze and long induction times, or an article with short induction time and high haze. Therefore, there is a need to reduce induction time and haze in articles made from blends of polyester with oxidizable organic polymers, where the oxidizable organic polymer is other than a partially aromatic polyamide.

In accordance with the present invention, it has now been found that the use of an ionic copolyester containing a metal compound when blended with an oxidizable polymer, other than a partially aromatic polyamide, can be used to make articles with a short induction time and low haze. Contrary to the teachings of the prior art, when an ionic compatibilizer is copolymerized to form the base polymer resin, it has been found that the addition of the metal compound during the preparation of the copolyester reduces the induction period and the haze of articles prepared by blending this copolyester with oxidizable polymers other than partially aromatic polyamides, compared with the use of a master batch.

In one aspect, a method for producing an oxygen scavenging resin is disclosed comprising: a) reacting an aromatic diacid or its diester, and an ionic diacid or its diester, with a diol and a metal compound to produce an ionic copolyester, b) cooling, cutting and drying the ionic copolyester into solid pellets, and c) mixing the dried ionic copolyester with a dried oxidizable polymer, provided that the oxidizable polymer is not a partially aromatic polyamide.

In another aspect, a composition is disclosed comprising an ionic copolyester, containing a metal compound, and an oxidizable polymer, provided that the oxidizable polymer is not a partially aromatic polyamide.

In a further aspect, a method for producing an article is disclosed comprising melting the above composition and molding the melt into an article.

### DETAILED DESCRITION OF THE INVENTION

One aspect of the disclosed method for producing an oxygen scavenging resin comprises: a) reacting an aromatic diacid or its diester, and an ionic diacid or its diester, with a diol and a metal compound to produce an ionic copolyester, b) cooling, cutting and drying the ionic copolyester into solid pellets, and c) mixing the dried ionic copolyester with a dried oxidizable polymer, provided that the oxidizable polymer is not a partially aromatic polyamide.

The reacting of step a) can be esterifying or transesterifying. The method can further comprise adding an additive after step a) and before step b). The method can further comprise solid state polymerizing ionic copolyester pellets after step b) and before step c).

The aromatic diacid or its diester can comprise at least 65 mol-% of terephthalic acid or C₁-C₄ dialkylterephthalate, based on the total moles of diacid or ester, for example at least 75 mol-% or at least 95 mol-%, based on the total moles of diacids or ester. The diol can comprise at least 65 mol-% of ethylene glycol, based on the total moles of diols, for example at least 75 mol-% or at least 95 mol-%, based on the total moles of diols.

The ionic diacids or its diester can have the formula:

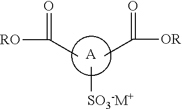

wherein R is hydrogen, a C₁-C₄-alkyl or a C₁-C₄-hydroxyalkyl,

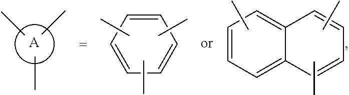

and M+ is a metal ion in a +1 or +2 valence state. The metal ion can be selected from the group consisting of alkali metals, alkaline earth metals and transition metals. The ionic diacid or its diester can be present in an amount of from about 0.01 to about 5 mol.-% of the total moles of diacid or ester, for example about 0.1 to about 2 mol-% of the total moles of diacids or ester.

The metal in the metal compound can be selected from the group consisting of the first, second and third group of the Periodic Table, for example the metal can be at least one member selected from the group consisting of cobalt, copper, rhodium, ruthenium, palladium, tungsten, osmium, cadmium, silver, tantalum, hafnium, vanadium, titanium, chromium, nickel, zinc, manganese and mixtures thereof. Suitable metal in the metal compound can be a salt of cobalt or zinc. The counter ion of the metal can be selected from the group consisting of carboxylates, such as neodecanoates, octanoates, stearates, acetates, naphthalates, lactates, maleates, acetylacetonates, linoleates, oleates, palminates or 2-ethyl hexanoates, oxides, borides, carbonates, chlorides, dioxides, hydroxides, nitrates, phosphates, sulfates, silicates and mixtures thereof. Suitable counter ion of the metal can be those selected with one from the group consisting of acetates, carbonates, stearates, oleates, neodecanoates and naphthalates. Suitable counter ion of the metal can be acetate, stearate and neodecanoates. For example, the metal can be selected from the group consisting of cobalt and zinc, and the counter ion can be selected from the group consisting of acetate, stearate and neodecanoate. The metal compound can be present in an amount of from about 25 to about 200 ppm, for example about 50 ppm to about 150 ppm, based on the weight of the ionic copolyester.

The ionic copolyester can have an intrinsic viscosity of about 0.6 to 1.0 dl/g, for example about 0.7 to about 0.85 dl/g.

The oxidizable polymer can be any polymer that contains an allylic, a benzylic or a α-hydrogen atom adjacent to a functional group such as an ether, acetal, diene or ketone, but not on the carbon atom attached to a nitrogen atom such as an amide. The α-hydrogen atoms are in the backbone of, or as a pendant side-chain to, the polymer chain. For example, the oxidizable polymer can be selected from the group consisting of copolyester ethers, polyesters containing polybutadiene and polyethylene containing benzylic pendant groups.

The amount of oxidizable polymer in the composition will depend on the shelf life requirement of the molded article such as an injection or blow molded container, thermoformed tray or film. The oxidizable polymer can be present in an amount of from about 1 to 10 weight %, for example about 2 to 7 weight %, of the ionic copolyester.

The additive can be selected from the group consisting of heat stabilizers, anti-blocking agents, antioxidants, antistatic agents, UV absorbers, toners (for example pigments and dyes), fillers, branching agents, or other typical agents which do not hinder the oxidation of said oxidizable polymer.

In another aspect, the disclosed methods are used to make a composition, for example the composition could comprise: ionic copolyester comprising a metal compound, and an oxidizable polymer, provided that the oxidizable polymer is not a partially aromatic polyamide.

In a further aspect, a method to produce an article is disclosed comprising: melting the said composition made by any of the methods described above, and molding the melt into an article. The article can be selected from the group consisting of film, sheet, tubing, pipes, fiber, container preforms, injection and blow molded articles such as rigid containers, thermoformed articles, flexible bags and the like and combinations thereof. The article comprises one or more walls comprising the composition.

Generally polyesters can be prepared by one of two processes, namely: (1) the ester process and (2) the acid process. The ester process is where a dicarboxylic ester (such as dimethyl terephthalate) is reacted with ethylene glycol or other diol in an ester interchange reaction. Because the reaction is reversible, it is generally necessary to remove the alcohol (methanol when dimethyl terephthalate is employed) to completely convert the raw materials into monomers. Certain catalysts are well known for use in the ester interchange reaction. In the past, catalytic activity was then sequestered by introducing a phosphorus compound, for example polyphosphoric acid, at the end of the ester interchange reaction. Primarily the ester interchange catalyst was sequestered to prevent yellowness from occurring in the polymer. Then the monomer undergoes polycondensation and the catalyst employed in this reaction is generally antimony, germanium, aluminum, tin or titanium compound, or a mixture of these.

In the second method for making polyester, an acid (such as terephthalic acid) is reacted with a diol (such as ethylene glycol) by a direct esterification reaction producing monomer and water. This reaction is also reversible like the ester process and thus to drive the reaction to completion one must remove the water. The direct esterification step does not require a catalyst. The monomer then undergoes polycondensation to form polyester just as in the ester process, and the catalyst and conditions employed are generally the same as those for the ester process.

In summary, in the ester process there are two steps, namely: (1) an ester interchange, and (2) polycondensation. In the acid process there are also two steps, namely: (1) direct esterification, and (2) polycondensation.

Suitable polyesters are produced from the reaction of a diacid or diester component comprising at least 65 mol-% terephthalic acid or C₁-C₄ dialkylterephthalate, for example at least 70 mol-% or at least 75 mol-% or at least 95 mol-%, and a diol component comprising at least 65% mol-% ethylene glycol, for example at least 70 mol-% or at least 75 mol-% or at least 95 mol-%. It is also suitable that the diacid component can be terephthalic acid and the diol component can be ethylene glycol, thereby forming polyethylene terephthalate (PET). The mole percent for all the diacid component totals 100 mol-%, and the mole percentage for all the diol component totals 100 mol-%.

Where the polyester components are modified by one or more diol components other than ethylene glycol, suitable diol components of the described polyester may be selected from 1,4-cyclohexandedimethanol, 1,2-propanediol, 1,4-butanediol, 2,2-dimethyl-1,3-propanediol, 2-methyl-1,3-propanediol (2MPDO) 1,6-hexanediol, 1,2-cyclohexanediol, 1,4-cyclohexanediol, 1,2-cyclohexanedimethanol, 1,3-cyclohexanedimethanol, and diols containing one or more oxygen atoms in the chain, e.g., diethylene glycol, triethylene glycol, dipropylene glycol, tripropylene glycol or mixtures of these, and the like. In general, these diols contain 2 to 18, preferably 2 to 8 carbon atoms. Cycloaliphatic diols can be employed in their cis or trans configuration or as mixture of both forms. Suitable modifying diol components can be 1,4-cyclohexanedimethanol or diethylene glycol, or a mixture of these.

Where the polyester components are modified by one or more acid components other than terephthalic acid, the suitable acid components (aliphatic, alicyclic, or aromatic dicarboxylic acids) of the linear polyester may be selected, for example, from isophthalic acid, 1,4-cyclohexanedicarboxylic acid, 1,3-cyclohexanedicarboxylic acid, succinic acid, glutaric acid, adipic acid, sebacic acid, 1,12-dodecanedioic acid, 2,6-naphthalenedicarboxylic acid, bibenzoic acid, or mixtures of these and the like. In the polymer preparation, it is often preferable to use a functional acid derivative thereof such as the dimethyl, diethyl, or dipropyl ester of the dicarboxylic acid. The anhydrides or acid halides of these acids also may be employed where practical. These acid modifiers generally retard the crystallization rate compared to terephthalic acid.

The copolyester can also be made by reacting at least 85 mol-% terephthalate from either terephthalic acid or dimethyl-terephthalate with any of the above comonomers.

In addition to polyester made from terephthalic acid (or dimethyl terephthalate) and ethylene glycol, or a copolyester as stated above, the disclosed methods also includes the use of 100% of an aromatic diacid such as 2,6-naphthalene dicarboxylic acid or bibenzoic acid, or their diesters, and a copolyester made by reacting at least 85 mol-% of the dicarboxylate from these aromatic diacids/diesters with any of the above comonomers.

The ionic copolyester is prepared by the methods stated above by adding an ionic comonomer containing a group that will react with the diacids or ester equivalents and/or diols during the polymerization. The ionic comonomer can be added with the diacids or ester equivalents and diols at the beginning of the polymerization. A suitable ionic comonomer is a metal sulfonate of a diacid having the formula

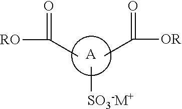

wherein R is hydrogen, a C₁-C₄-alkyl or a C₁-C₄-hydroxyalkyl, and

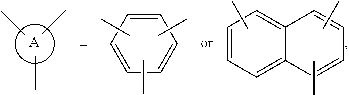

with the attachments preferably in the 1-, 3- and 5-position (for the phenyl ring) and in 2-,4- and 6-position (for the naphthyl ring), and M+ being a metal ion in a +1 or +2 valence state which can be selected from the group comprising the alkali metals (Li, Na and K), or from the group consisting of alkaline earth metals (Mg, Ca and Sr) or from the group consisting of transition metals (Cr, Mn, Fe, Co, Ni, Cu, Zn, Co).

The metal compound, which functions as a catalyst for the oxidation of the oxidizable polymer, can be added anywhere during the polymerization, suitably prior to polycondensation for compounds that are stable for the time to complete polymerization, or after polymerization for less stable compounds, prior to extrusion into strands, quenching and cutting the strands into pellets.

The intrinsic viscosity (IV) of the ionic copolyester can be in the range of about 0.6 to about 1.0 dl/g, for example in the range of about 0.7 to about 0.85 dl/g. These molecular weights can be manufactured directly from the melt polymerization, or from a 2-step process in which an amorphous copolyester is prepared with an IV of 0.45 to 0.6 dl/g, crystallized and solid state polymerized by conventional methods to the desired IV.

The disclosed methods can further comprise adding an additive that does not inhibit the oxidation of the composition. The additive can be selected from heat stabilizers, anti-blocking agents, antioxidants, antistatic agents, UV absorbers, toners (for example pigments and dyes), fillers, branching agents, or other typical agents. The additive can be added to the composition generally during or near the end of the polycondensation reaction or during injection molding or extrusion. Conventional systems can be employed for the introduction of additives to achieve the desired result.

The composition made by the disclosed methods can be used in articles of manufacture. Suitable articles include, but are not limited to, film, sheet, tubing, pipes, fiber, container preforms, blow molded articles such as rigid containers, thermoformed articles, flexible bags and the like and combinations thereof. Typical rigid or semi-rigid articles can be formed from plastic, paper or cardboard cartons or bottles such as juice, milk, soft drink, beer and soup containers, thermoformed trays or cups. In addition, the walls of such articles often comprise multiple layers of materials. This invention can be used in one, some, or all of those layers.

### Test Procedures

1. Intrinsic Viscosity

The intrinsic viscosity of the copolyester-ether was measured according the ASTM D 4603, using m-cresol as the solvent.

2. Bottle Oxygen Transmission Rate

Oxygen flux of bottle samples at ambient relative humidity, at one atmosphere pressure, and at 23° C. was measured with a Mocon Ox-Tran model 2/60 (MOCON Minneapolis, Minn.). A mixture of 98% nitrogen with 2% hydrogen was used as the carrier gas, and ambient air (20.9% oxygen) was used as the test gas. Prior to testing, specimens were conditioned in nitrogen inside the unit for a minimum of twenty-four hours to remove traces of atmospheric oxygen. The conditioning was continued until a steady base line was obtained where the oxygen flux changed by less than one percent for a 45-minute cycle. The test ended when the flux reached a steady state where the oxygen flux changed by less than 1% during a 45 minute test cycle. Oxygen Permeation results are measured and recorded as cm³/package/day. To measure the Barrier Improvement Factor or “BIF”; a control bottle containing no oxygen scavenger is measured at the same time as the test bottles under identical conditions. The BIF is calculated by dividing the oxygen permeation of the control bottle, by the oxygen permeation of the test bottle. In order to facilitate determination of an induction period prior to onset of oxygen scavenging, a BIF value of 10.0X is used. This implies that the test bottle has a rate of permeation to oxygen of no more than 10% of the control bottle.

3. Haze and Color

The haze of the preform and bottle walls was measured with a Hunter Lab ColorQuest II instrument. D65 illuminant was used with a CIE 1964 10° standard observer. The haze is defined as the percent of the CIE Y diffuse transmittance to the CIE Y total transmission. Unless otherwise stated the % haze was measured on the sidewall of a stretch blow molded bottle having a thickness of 0.25 mm. The color of the preform and bottle walls was measured with the same instrument and was reported using the CIELAB color scale, L* is a measure of brightness, a* is a measure of redness (+) or greenness (−) and b* is a measure of yellowness (+) or blueness (−).

4. Metal Content

The metal content of the ground polymer samples was measured with an Atom Scan 16 ICP Emission Spectrograph. The sample was dissolved by heating in ethanolamine, and on cooling, distilled water was added to crystallize out the terephthalic acid. The solution was centrifuged, and the supernatant liquid analyzed. Comparison of atomic emissions from the samples under analysis with those of solutions of known metal ion concentrations was used to determine the experimental values of metals retained in the polymer samples. This method is used to determine the cobalt concentration in the composition.

5. Preform and Bottle Process

Unless otherwise stated, the polymers, copolymers and oxidizable polymers of the present invention were dried for about 30 hours at 85-110° C., blended with the dried base resin and a dried master batch of the transition metal catalyst, melted and extruded into preforms. Each preform for a 0.5 liter soft drink bottle, for example, employed about 24-25 grams of the resin. The preform was then heated to about 85-120° C. and blown-molded into a 0.5 liter contour bottle at a stretch ratio of about 12.5. The sidewall thickness was 0.25 mm.

### EXAMPLES

### Example 1

Master Batch—MB1

A master batch of an ionic copolyester was prepared using a dimethyl terephthalate (DMT) process and the sodium salt of dimethyl 5-sulfoisophthalate using a zinc acetate ester interchange catalyst, sequestered with polyphosphoric acid, and antimony trioxide as the polycondensation catalyst, containing 3.65 wt.-%, based on the weight of the ionic copolyester, of 5-sulfoisophthalic acid. This master batch was compounded with cobalt stearate to give a final resin containing 1375 ppm Co (measured as elemental Co, based on the weight of the master batch).

Master Batch—MB2

A master batch of an ionic copolyester was prepared using a DMT process and the sodium salt of dimethyl 5-sulfoisophthalate using a zinc acetate ester interchange catalyst, sequestered with polyphosphoric acid, and antimony trioxide as the polycondensation catalyst with cobalt acetate (2000 ppm) added after the ester interchange, containing 3.65 wt.-%, based on the weight of the ionic copolyester, of 5-sulfoisophthalic acid.

### Ionic Copolyester—IC1

An ionic copolyester was prepared using a direct esterification process to give 0.18 wt.-% SIPA in the resin. Cobalt stearate (70 ppm Co) was added at the end of the polycondensation.

### Ionic Copolyester—IC2

An ionic copolyester was prepared using a direct esterification process to give 0.18 wt.-% SIPA in the resin. After esterification cobalt acetate (100 ppm Co) in an ethylene glycol slurry was added to the monomer.

### Copolyester-Ether—COPE

DMT, a molar excess of glycol, and zinc acetate (70 ppm Zn) as the ester interchange catalyst were charged into a reactor equipped with a condenser, reflux column and stirrer. The materials, which were stirred continuously during the trans-esterification, were heated to a temperature of 160-230° C. under atmospheric pressure until the ester interchange reaction was complete, as evidenced by the amount of methanol removed. The mixture was transferred to an autoclave, poly(tetramethylene oxide) glycol, having a number average molecular weight of 1400 g/mole, was added, equivalent to 50 weight % of the final polymer weight, together with Vertec® AC420 (Johnson Mathey, USA) (30 ppm Ti) as a polycondensation catalyst. The autoclave pressure was reduced to <0.3 mm Hg, and then the temperature was increased to 250° C. The mixture, which was stirred continuously during the polymerization, was held at this temperature until the required melt viscosity, as measured by the stirrer amperage, was met. The reactor was pressurized slightly with nitrogen and the product extruded into chilled water. After the polymer strand cooled, it was pelletized with Scheer-bay pelletizer. The intrinsic viscosity of the copolyester-ether was about 1.2 dl/g.

### Example 2

### Comparative

A polyester bottle resin (INVISTA PolyClear® resin, type 2201) was dry blended with 5 wt.-% of MB1 masterbatch, 2.2 wt.-% of COPE and injection molded into preforms. These preforms were stretch blow molded into 500 ml bottles. The copolyester composition of these bottles comprises 0.18 wt-% SIPA and 70 ppm Co. The bottle average haze, induction period and final oxygen transmission rate were measured and the results set forth in Table 1.

### Example 3

### Comparative

A polyester bottle resin (INVISTA PolyClear® resin, type 2201) was dry blended with 5 wt.-% of MB2 masterbatch, 2.0 wt.-% of COPE and injection molded into preforms. These preforms were stretch blow molded into 500 ml bottles. The copolyester composition of these bottles comprises 0.18 wt-% SIPA and 100 ppm Co. The bottle average haze, induction period and final oxygen transmission rate were measured and the results set forth in Table 1.

### Example 4

### Control

The ionic copolyester (IC1) was injection molded into preforms, which were stretch blow molded into 500 ml bottles. The bottle average haze and final oxygen transmission rate were measured and the results set forth in Table 1.

### Example 5

### Inventive

The ionic copolyester, IC1, was dry blended with 1.8 wt.-% of COPE. The blend was injection molded into preforms, which were stretch blow molded into 500 ml bottles. The bottle average haze, induction period and final oxygen transmission rate were measured and the results set forth in Table 1.

### Example 6

### Inventive

The ionic copolyester, IC2, was dry blended with 1.9 wt.-% of COPE. The blend was injection molded into preforms, which were stretch blow molded into 500 ml bottles. The bottle average haze, induction period and final oxygen transmission rate were measured and the results set forth in Table 1.

### Example 7

### Control

A standard bottle resin (INVISTA Type 1101) was injection molded into preforms, which were stretch blow molded into 500 ml bottles. The bottle average haze and final oxygen transmission rate were measured and the results set forth in Table 1.

### Example 8

### Comparative

A dry blend of INVISTA Type 1101 and 2 wt.-% of COPE was injection molded into preforms, which were stretch blow molded into 500 ml bottles. The bottle average haze was measured and the results set forth in Table 1.

### Example 9

### Inventive

IC2 was dry blended with 2, 2.5 and 3 wt.-% of COPE. This blend was injection molded into preforms, which were stretch blow molded into 500 ml bottles. The bottle average haze was measured and the results set forth in Table 1.

### Example 10

### Comparative

A dry blend of INVISTA Type 1101 and 3 wt.-% of Amosorb® resin (an oxidizable polyester containing about 10 wt. % polybutadiene segments) was injection molded into preforms, which were stretch blow molded into 500 ml bottles. The bottle average haze was measured and the results set forth in Table 1.

### Example 11

### Inventive

IC2 was dry blended with 3 wt.-% of Amosorb® resin and injection molded into preforms, which were stretch blow molded into 500 ml bottles. The bottle average haze was measured and the results set forth in Table 1.

TABLE 1

| | | | | Oxidizable | | | | |
|---|---|---|---|---|---|---|---|---|
| | Base | Master Batch | | polymer | | | Induction | O2 transmission |
| Example | Resin | | Wt.-% | Type | Wt.-% | Haze, % | time, day | rate, cm³ · bottle⁻¹ · day⁻¹ |
| 2 Comp. | 2201 | MB1 | 5 | COPE | 2.2 | 2.3 | 16 | .0021 |
| 3 Comp. | 2201 | MB2 | 5 | COPE | 2.0 | 2.4 | 8 | .0001 |
| 4 Control | IC1 | | | | | 1.0 | | .056 |
| 5 Inv. | IC1 | | | COPE | 1.8 | 1.3 | 3 | .0013 |
| 6 Inv. | IC2 | | | COPE | 1.9 | 1.5 | 6 | .0030 |
| 7 Control | 1101 | | | | | 1.5 | | .056 |
| 8 Comp. | 1101 | | | COPE | 2.0 | 3.2 | | |
| 9a Inv. | IC2 | | | COPE | 2.0 | 1.6 | | |
| 9b Inv. | IC2 | | | COPE | 2.5 | 2.0 | | |
| 9c Inv. | IC2 | | | COPE | 3.0 | 2.2 | | |
| 10 Comp. | 1101 | | | Amosorb | 3.0 | 5.7 | | |
| 11 Inv. | IC2 | | | Amosorb | 3.0 | 4.6 | | |

Contrary to prior art teachings, an ionic copolyester is more effective than a master batch in reducing the haze and decreasing the induction period for bottles made from blends with oxidizable polymers, which are not partially aromatic polyamide oxidizable polymers. Specifically, an ionic copolyester with 70 ppm of cobalt stearate and 1.8% COPE oxidizable polymer had a 77% reduction in haze and a 433% reduction in induction period compared to a similar copolyester made from a master batch. (Compare Example 5 to Example 2). Similarly, an ionic copolyester with 100 ppm of cobalt acetate and 1.9% COPE oxidizable polymer had a 60% reduction in haze and a 33% reduction in induction period compared to a similar copolyester made from a master batch. (Compare Example 6 to Example 3). These results are surprising and unexpected, especially in light of the prior art teachings that an ionic copolyester made with the metal compound is less effective than a master batch in reducing haze.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims.

What is claimed is:

1. A method for producing an oxygen scavenging resin comprising:
i. reacting an aromatic diacid or its diester, and an ionic diacid or its diester, with a diol and a metal compound to produce an ionic copolyester,
ii. cooling, cutting and drying the ionic copolyester into solid pellets, and
iii. mixing the dried ionic copolyester with a dried oxidizable polymer, provided that the oxidizable polymer is not a partially aromatic polyamide.

2. The method of claim 1 wherein the reacting of step a) is esterifying or transesterifying.

3. The method of claim 1 or 2 further comprising adding an additive after step a) and before step b).

4. The method of any one of claims 1-3 further comprising solid state polymerizing ionic copolyester pellets after step b) and before step c).

5. The method of claim 1 wherein the aromatic diacid or its diester comprises at least 65 mol-% of terephthalic acid or C₁-C₄ dialkylterephthalate, based on the total moles of diacid or ester.

6. The method of claim 1 wherein the aromatic diacid or its diester comprises at least 75 mol-% of terephthalic acid or C₁-C₄ dialkylterephthalate, based on the total moles of diacid or ester.

7. The method of claim 1 wherein the aromatic diacid or its diester comprises at least 95 mol-% of terephthalic acid or C₁-C₄ dialkylterephthalate, based on the total moles of diacid or ester.

8. The method of claim 1 wherein the diol comprises at least 65 mol-% of ethylene glycol, based on the total moles of diols.

9. The method of claim 1 wherein the diol comprises at least 75 mol-% of ethylene glycol, based on the total moles of diols.

10. The method of claim 1 wherein the diol comprises at least 95 mol-% of ethylene glycol, based on the total moles of diols.

11. The method of any of claims 1 to 10 wherein said ionic diacid or its diester has the formula: 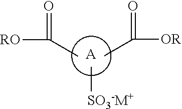
wherein R is hydrogen, a C₁-C₄-alkyl or a C₁-C₄-hydroxyalkyl, 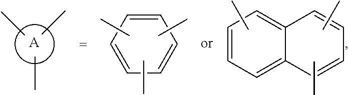
and M+ is a metal ion in a +1 or +2 valence state.

12. The method of claim 11 wherein the ionic diacid or its diester is present in an amount of from about 0.01 to about 5 mol.-% of the total moles of diacid or ester.

13. The method of claim 11 wherein the ionic diacid or its diester is present in an amount of from about 0.1 to about 2 mol.-% of the total moles of diacid or ester.

14. The method of any one of claims 11 to 13 wherein the metal ion is selected from the group consisting of alkali metals, alkaline earth metals and transition metals.

15. The method of any one of claims 1 to 14 wherein metal in the said metal compound is selected from the group consisting of the first, second and third group of the Periodic Table.

16. The method of claim 15 wherein said metal is at least one member selected from the group consisting of cobalt, copper, rhodium, ruthenium, palladium, tungsten, osmium, cadmium, silver, tantalum, hafnium, vanadium, titanium, chromium, nickel, zinc, manganese and mixtures thereof.

17. The method of any one of claims 15 and 16 wherein the counter ion of said metal is at least one member selected from the group consisting of carboxylates, such as neodecanoates, octanoates, stearates, acetates, naphthalates, lactates, maleates, acetylacetonates, linoleates, oleates, palminates or 2-ethyl hexanoates, oxides, borides, carbonates, chlorides, dioxides, hydroxides, nitrates, phosphates, sulfates, silicates and mixtures thereof.

18. The method of claim 17 wherein said metal is selected from the group consisting of cobalt and zinc, and said counter ion is selected from the group consisting of acetate, stearate and neodecanoate.

19. The method of any one of claims 15 to 18 wherein said metal compound is in amount of about 25 to about 200 ppm based on the weight of the ionic copolyester.

20. The method of claim 19 wherein said metal compound is in amount of about 50 to about 150 ppm based on the weight of the ionic copolyester.

21. The method of any one of claims 1-20 wherein said ionic copolyester has an intrinsic viscosity of about 0.6 to 1.0 dl/g.

22. The method of clam 21 wherein said intrinsic viscosity is about 0.7 to about 0.85 dl/g.

23. The method of any one of claims 1 to 22 wherein said oxidizable polymer is a polymer comprising an allylic, a benzylic or a α-hydrogen atom adjacent to a functional group, wherein the a-hydrogen atoms is in the backbone of, or as a pendant side-chain to, the polymer chain.

24. The method of clam 23 wherein said polymer is selected from the group consisting of copolyester ethers, polyesters containing polybutadiene and polyethylene containing benzylic pendant groups.

25. The method of claim 23 or 24 wherein said oxidizable polymer is present in an amount of from about 1 to 10 weight % of the ionic copolyester.

26. The method of claim 25 wherein said oxidizable polymer is present in an amount of from about 2 to 7 weight % of the ionic copolyester.

27. The method of claim 3 or 11 wherein said additive is selected from the group consisting of heat stabilizers, anti-blocking agents, antioxidants, antistatic agents, UV absorbers, toners (for example pigments and dyes), fillers, branching agents, or other typical agents which do not hinder the oxidation of said oxidizable polymer.

28. A composition made by any one of the methods of claims 1 to 27.

29. A method to produce an article comprising: melting the said composition of claim 28, and molding the melt into an article.

30. The method of claim 29 wherein the said article is selected from the group consisting of film, sheet, tubing, pipes, fiber, container preforms, injection and blow molded articles such as rigid containers, thermoformed articles, flexible bags and the like and combinations thereof.

31. The method of claim 30 wherein said article comprises one or more walls comprising the composition.
